(19) United States
(12) Patent Application Publication
(10) Pub. No.: US 2004/0197050 A1
(43) Pub. Date: Oct. 7, 2004

(54) Optical distributed sensor with bragg grating sensing structure

(76) Inventors: Sigurd Weidemann Lovseth, Trodheim (DE); Jon Thomas Kringlebotn, Trondheim (DE)

Correspondence Address: William B Patterson, Moser Patterson & Sheridan, Suite 1500, 3040 Post Oak Blvd, Houston, TX, 77056, US

(21) Appl. No.: 10/479,103

(22) PCT Filed: May 22, 2002
(86) PCT No.: PCT/NO02/00180

(30) Foreign Application Priority Data
May 25, 2001 (NO) 2001.2593

(51) Int. Cl. G02B 6/34

(52) U.S. Cl. 385/37; 385/13

(57) ABSTRACT

Optical device for distributed sensing of a measurand and/or changes thereof where the spectral transmission and reflection characteristics of the device depend upon the measurand. A passive sensing section have at least one Bragg grating sensing structure in a waveguide. The Bragg grating sensing structure comprises at least two superimposed or partly overlapping Bragg subgratings with at least two different Bragg wavelengths. At least two of the said Bragg subgratings comprise a phase-shift. The Bragg subgratings have their phase shifts spatially separated from each other along the waveguide sensing section. The sensing section can be made active by at least partly doping it with rare earth ions and forming a laser medium, or an active component. Examples of using the passive as well as the active sensing sections in optical distributed sensors are described.

This invention relates to optical waveguide sensor devices comprising two or more overlapped Bragg gratings. Each grating has a phase shift, i.e. a longitudinal discontinuity in the normally periodic structure of the Bragg grating. The waveguide device may or may not be doped with rare earth ions.

In optical fiber distributed sensor applications it is a well known approach to multiplex several fiber Bragg grating (FBG) sensors [1] along the same fiber. The center frequency v_{Bi} of the main peak in the reflection spectrum of an FBG, also known as the stop band, for light in polarization i is given by:

$${v}_{Bi} = \frac{c}{{λ}_{Bi}} = \frac{c}{2 {n}_{i} Λ} \qquad ( 1 )$$

v_{Bi} is also known as the center Bragg frequency and λ_{Bi} is the Bragg wavelength. In equation (1), c is the speed of light, nᵢ, i=x,y is the generally polarization dependent refractive index where x and y represents the two orthogonal polarization states of the waveguide, and Λ is the periodicity of the grating. Thus, a perturbation of nᵢ or Λ by a measurand will be detected as a shift of the Bragg frequency v_{Bi}. When the FBG sensors are multiplexed, the localization of the perturbation can be determined by using different periodicity for each grating. Similar quasi-distributed sensing can be achieved with Bragg grating based fiber lasers with rare earth doped fiber.

An important characterizing parameter of the Bragg grating in distributed sensor applications is the spatial resolution. Bragg gratings can be made quite short, limited by the UV beam size during the grating inscription. Alternatively, intra-grating perturbations of a Bragg structure can be measured by simultaneously measuring the group delay and the power of the reflection spectrum [2]. However, when using conventional FBGS, an increase in spatial resolution invariably will lead to lower sensibility. Hence, there is a demand for improved spatial resolution in such applications.

By introducing a phase shift in an otherwise uniform Bragg grating, the two gratings at each side of the phase shift will act as the mirrors of an optical resonator, and there will be a narrow notch in the reflection spectrum of the grating [3]. This notch may be referred to as the phase shift notch, the center wavelength of which can be referred to as the notch wavelength. If the phase shift equals π the notch wavelength coincides with Bragg wavelength of a uniform Bragg grating.

As with ordinary Fabry-Perot cavities, we have no reflection at the resonance if the mirror strengths of the cavity are equal, meaning that the integrated coupling strengths of the two grating halves are equal. The phase shift notch is typically very narrow (less than one pm) compared with the stop band of the grating, and it will have a frequency splitting Δv=v_{B}B/n, where B=nₓ−n_{y} is the birefringence in the grating or fiber. If we have a uniform physical perturbation across the grating, the phase shift notch and Bragg wavelength will move in the same direction, with both shifts controlled by equation (1). Thus because of the narrowness of the phase shift notch, much smaller perturbations can be measured than for conventional FBGs. Since different measurands perturb the birefringence to different degrees, simultaneous measurements of two measurands can be achieved by measuring the phase shift notches of both polarizations.

By writing a FBG in a rare earth doped fiber, it is possible to make distributed feedback lasers (DFB-FL). Stable single longitudinal mode operation can be achieved by adding a phase shift to the grating structure [4]. Single polarization operation, if wanted, can be obtained for instance by using polarization dependent gratings. The linewidth of the laser modes can be in the kHz range. An advantage of DFB-FL sensors compared with the passive phase shifted FBGs is that no complex opto-electronics is needed to interrogate the sensor. Just like phase shifted FBGs, dual polarization DFB-FLs can be used to simultaneously measure two measurands [5].

For passive as well as active phase shifted FBG sensors, it is important to note that the effective cavity length is inversely proportional to the grating strength. Thus, the sensor has an effective length that is far shorter than the length of the grating [6].

FBGs with periodic superstructures are often called sampled gratings or multiple wavelength fiber Bragg gratings (MW-FBG). A simple sinusoidal sampling function corresponds to a superposition of two uniform Bragg gratings with different v_{B}. The reflection spectra of such gratings will have two reflection peaks slightly detuned from the stop bands of the two superimposed Bragg gratings. By using more complex sampling functions, or superimpose more gratings with different periodicity Λ, gratings with several reflection peaks with similar shapes and widths can be achieved [7]. However, the maximum refractive index that can be achieved in a fiber grating is limited by the photo-sensitivity. Thus, the maximum achievable reflection strength will decline with an increasing number of superimposed uniform Bragg gratings.

Recently, dual wavelength DFB-FLs were reported, using dual wavelength FBGs with a center phase shift [8]. It is possible to make DFB-FL with more modes, but the maximum number of modes is limited by the available photo-sensitivity of the fiber. We call such lasers for multiple wavelength DFB-FLs (MW-DFB-FLs).

The objective of the invention is to provide fiber optic quasi-distributed sensors with high spatial resolution, down to millimeters, and high resolution in the measurand. The measurand may be any physical quantity that could change the effective index or length of the optical fiber, for instance acoustic and static pressure, force, temperature, or strain.

A second objective is to provide a sensor that measures a gradient of the measurand.

A third objective is to be able to have simultaneously quasi-distributed measurements of two measurands.

A fourth objective is to provide a fiber Bragg grating that have an effective utilization of the available photo-sensitivity of the optical fiber.

The objectives as set out above can be met by providing an optical device for distributed sensing of a measurand and/or changes thereof where the spectral transmission and reflection characteristics of the device depend upon the measurand. The device comprises a sensing section having at least one Bragg grating sensing structure in a waveguide. The Bragg grating sensing structure comprises at least two superimposed or partly overlapping Bragg subgratings. The Bragg sensing structure has at least two different peak reflection wavelengths. At least two of the Bragg subgratings comprises a phase shift. The Bragg subgratings have their phase shifts spatially separated from each other along the waveguide sensing section.

The objectives can also be met by providing an optical device as above with a sensing section at least partly doped with rare earth ions which when pumped by a pump source, for example a high-power semiconductor laser, provides lasing at wavelengths determined by the gratings.

The objectives are also met by providing an optical distributed sensor according to the invention for sensing an external physical parameter wherein a tunable optical narrowband optical source is providing light to one input port of an optical waveguide coupling section. One output port of the coupling section is coupled directly, or via a waveguide lead section, to one end of an optical waveguide sensing section. The other end of the sensing section is connected directly, or via another waveguide lead section, to a first optical detection means 18 for allowing a measure of light transmitted through the sensing section. A second input port of the coupling section is coupled to a second optical detection means for allowing a measure of light reflected by the sensing section. The sensing section comprises at least one Bragg grating sensing structure in a waveguide. The Bragg grating sensing structure has at least two superimposed or partly overlapping Bragg subgratings. The Bragg subgratings have at least two different peak reflection wavelengths. At least one of the Bragg subgratings comprises a phase shift, the phase shifts being spatially separated from each other along the waveguide sensing section.

The objectives can also be met by providing an optical distributed sensor for sensing an external physical parameter according to the invention where an optical pump source provides light to a first input port of a wavelength division coupler/multiplexer. One port of the coupler/multiplexer is coupled directly, or via a waveguide lead section section, to one end of an optical waveguide sensing section. A second port of the optical coupler/multiplexer is connected to optical detection means for monitoring light from the sensing section. The sensing section comprises at least two Bragg grating sensing structure in a waveguide at least partly doped with rare earth ions. The Bragg grating sensing structure comprises at least two superimposed or partly overlapping Bragg subgratings and has at least two different peak wavelengths. At least one of the Bragg subgratings comprises a phase shift, the phase shifts being spatially separated from each other along the waveguide sensing section.

If we have more than two subgratings, the phase between the subgratings can be optimized for efficient use of the available photosensitivity. For N_{g} subgratings with equal strength κᵢ, the maximum possible value of the total coupling function |κₜₒₜ| is N_{g}κᵢ. |κₜₒₜ| will be proportional to the required photosensitivity. It can be shown that by optimizing the relative phase between the subgratings, the maximum value of |κₜₒₜ| can be reduced from N₉κᵢ to √N_{g}κᵢ (for large values of N_{g}), because of cancellations between the different Moiré patterns. Note that it will not be possible to maintain this ideal phase relation everywhere in the MW-FBG/MW-DFB-FL sensor structure since the subgrating phase shifts are not co-located.

It is important to choose the right method of grating fabrication in order to utilize the full potential of the cancellations between the different Moiré patterns. There are two principal ways of fabricating MW-FBGs. Either the MW-FBGs are produced by overlaying the subgratings one by one, or they are fabricated by writing a grating with a complex sampling function with an index profile equal to the sum of the individual subgratings. In the latter method the relative phases between the subgratings can be accurately controlled. However, the maximum Bragg frequency spacing between the subgratings with this method will be limited by the spatial resolution (UV laser spot size) in the writing setup. To obtain a large spacing the former method can be used. However, in this case it may be difficult to control the relative phases between the subgratings with sufficient accuracy. Even if the relative phases are ideally optimized, each subgrating will also contribute to a shift in the mean refractive index that is independent of its phase, so the lower limit to the needed refractive index contrast for the MW-FBG corresponds to a grating of strength (N_{g}+_[(N_{g})])κᵢ/2. Thus, writing the subgratings one by one is a good idea if the sensor application requires a large dynamic range or a high linearity, which means that a large frequency spacing between the subgrating is needed. However, if a large number of subgratings, and thus efficient use of the photosensitivity is most important, the MW-FBG grating structures should be written in one scan using a complex sampling function.

Further preferred embodiments of the invention are defined in the subclaims.

The invention will be described in detail below with reference to the accompanying drawings, illustrating the invention by way of examples.

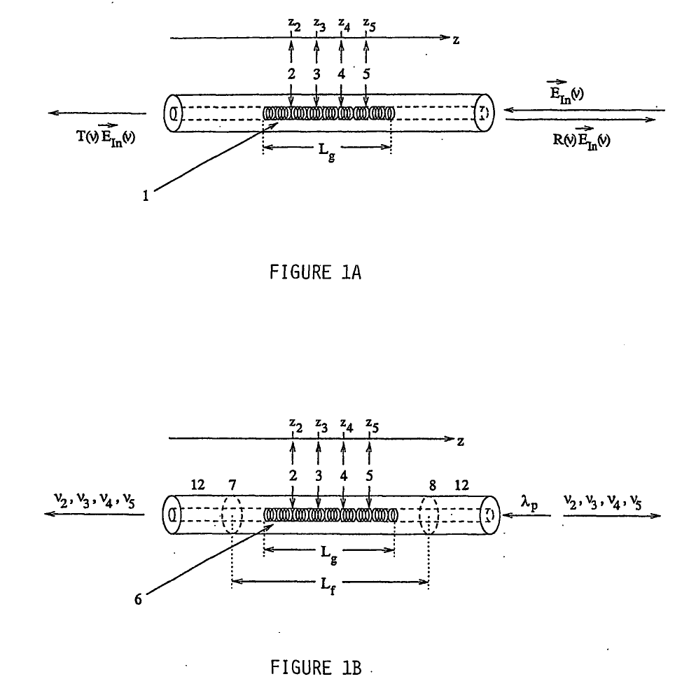

FIG. 1A shows an MW-FBG sensor consisting of four overlaid subgratings with different pitch, having their phase shift located at different positions.

FIG. 1B shows an MW-DFB-FL sensor operating at four wavelengths, constructed by superimposing four phase shifted subgratings, each having a phase shift located at a different position.

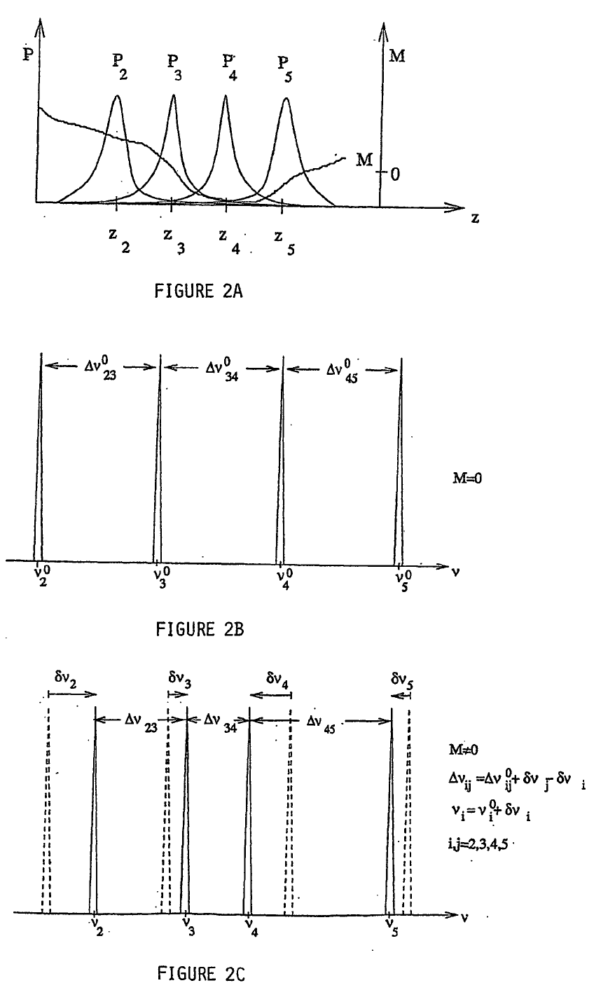

FIG. 2A illustrates schematically the spatial distribution of the resonant states of an MW-FBG or an MW-FBG-FL sensor with the subgrating phase shift positions separated together with the spatial distribution of a measurand M.

FIG. 2B-C illustrates schematically the effect on the different resonant frequencies induced by the spatially varying measurand M.

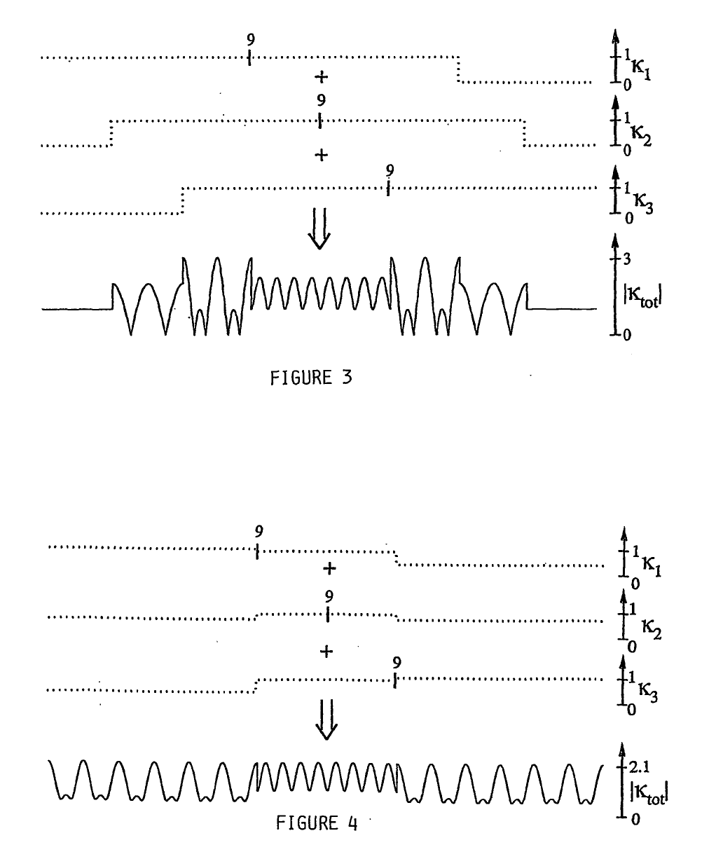

FIG. 3 illustrates a superposition of three uniform phase shifted FBGs with different periodicity, and spatially separated phase shifts.

FIG. 4 illustrates a superposition of three phase shifted FBGs with different periodicity, spatially separated phase shifts, and amplitude and phase of the superimposed gratings optimized for efficient use of photo-sensitivity.

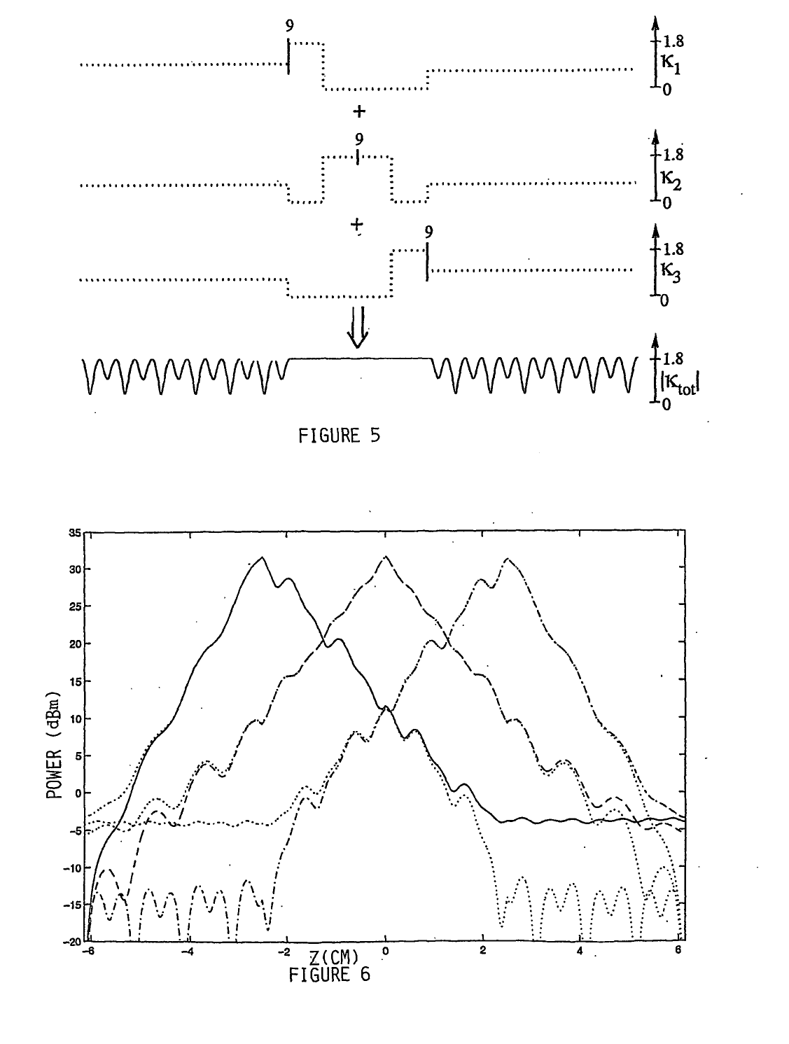

FIG. 5 illustrates an alternative superposition of three phase shifted FBGs with different periodicity, spatially separated phase shifts, and amplitude and phase of the superimposed gratings optimized for efficient use of the photo-sensitivity.

FIG. 6 shows a plot of the mode field distribution of a MW-DFB-FL with grating structure as illustrated in

FIG. 4 and a detuning betweeen the Bragg frequencies of the superimposed gratings of Δv_{B}=10 Ghz.

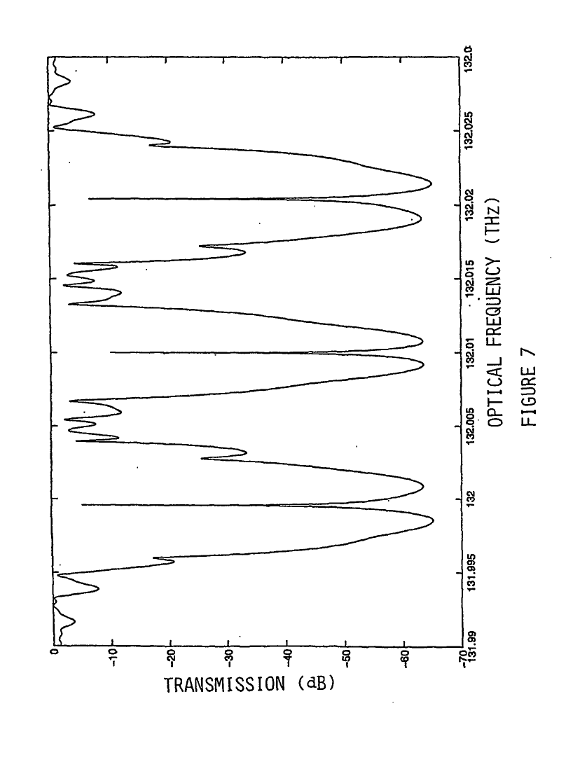

FIG. 7 shows the transmission spectrum of a MW-FBG of the type illustrated in FIG. 4 and with Δv_{B}=10 GHz.

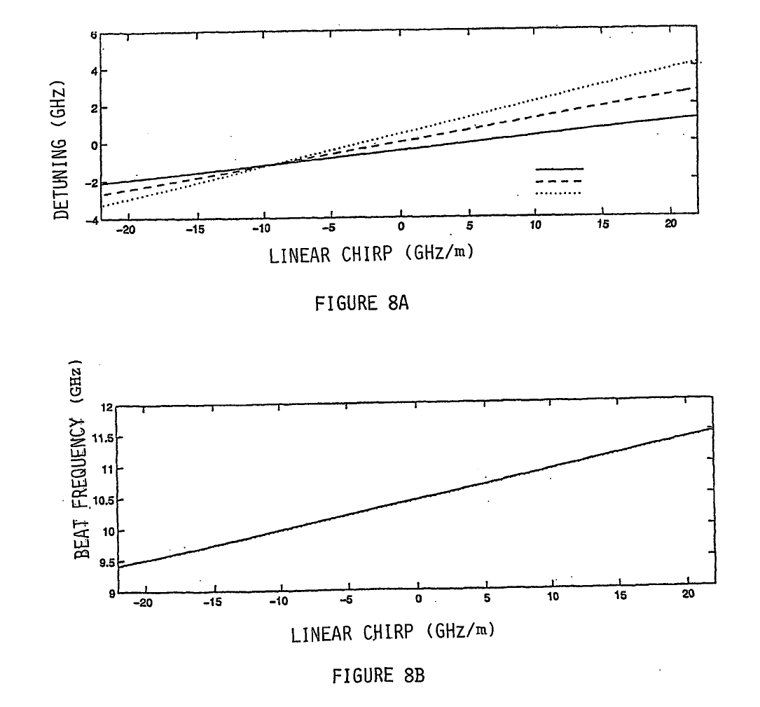

FIG. 8A shows a plot of the detuning of the three modes plotted in FIG. 6 as a function of linear chirp,

FIG. 8B shows a plot of the beat frequencies between the modes plotted in FIG. 6 as a function of linear chirp.

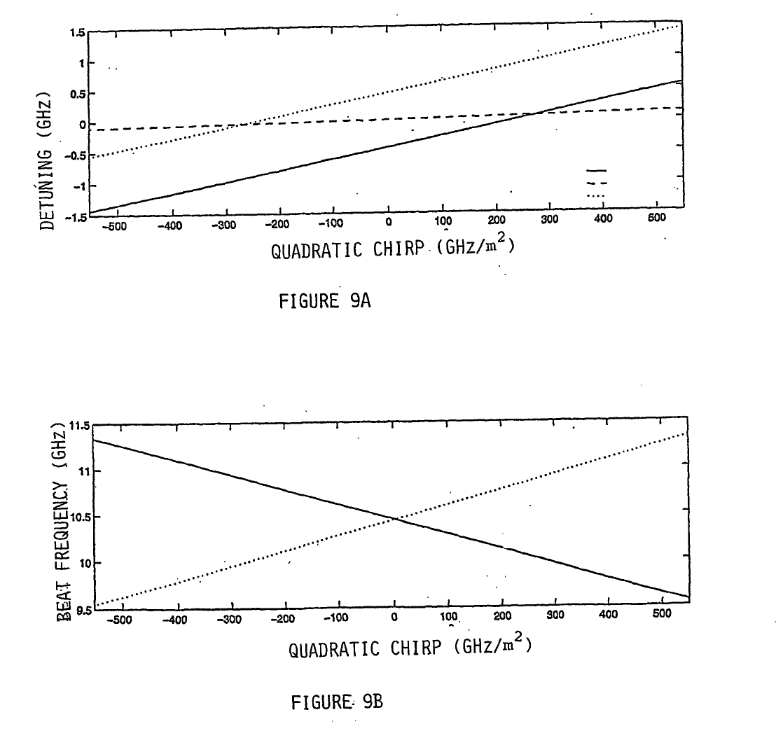

FIG. 9A shows plot of the detuning of the three modes plotted in FIG. 6 as a function of quadratic chirp.

FIG. 9B shows a plot of the beat frequencies between the modes plotted in FIG. 6 as a function of the quadratic chirp.

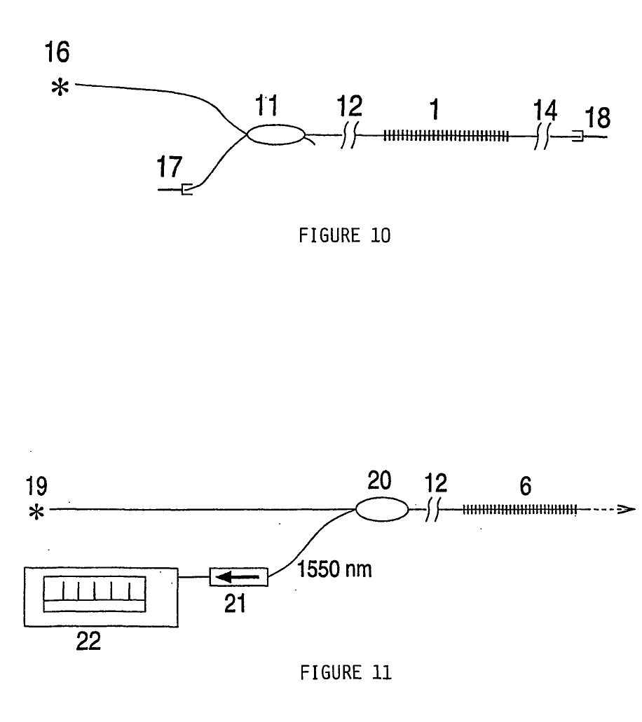

FIG. 10 shows a typical interrogation setup of a multiple wavelength MW-DFB-FL sensor with the phase shifts spatially separated using a tunable laser.

FIG. 11 shows a typical interrogation setup of a multiple wavelength MW-DFB-FL sensor with the phase shifts spatially separated.

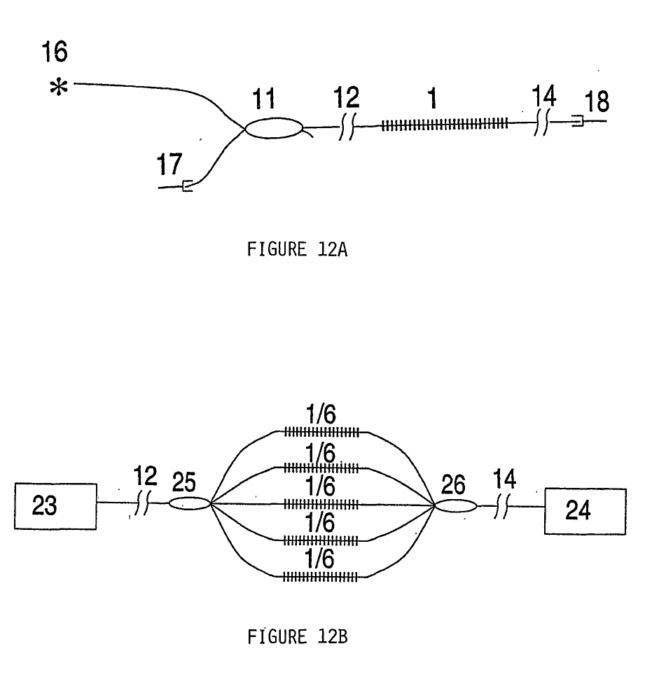

FIG. 12A shows schematically serial multiplexing of MW-FBG or MW-DFB-FL sensors.

FIG. 12B shows schematically parallel multiplexing of MW-FBG-FL sensors.

FIG. 1A shows, in a first preferred embodiment of the invention, a multiple wavelength fiber Bragg grating (MW-FBG) 1 with length L_{g}. The grating can be viewed as a super-position of four uniform Bragg subgratings with different Bragg frequencies, leading to a reflection R(v) and transmission T(v) spectrum characterized by multiple transmission stop bands, one per superimposed grating. Each subgrating has a discrete or slightly distributed phase shift located at the positions z₂, z₃, z₄, and z₅, respectively, leading to distinctive phase shift notches in each of the grating reflective spectra.

FIG. 1B shows, in a second preferred embodiment of the invention, a grating similar to the one shown in FIG. 1A with length L_{g} written in a rare earth doped optical fiber of length L_{f}. Given a strong enough MW-FBG and enough gain, such a device is called a multiple wavelength distributed feedback laser (MW-DFB-FL) 6. The rare earth doped fiber is in the preferred embodiment spliced to a conventional optical fiber in one or both ends with connections 6 and 7. If end pumped by sufficient power at the optical pump wavelength λₚ, the grating structure will support multiple lasing modes with frequencies v₂, v₃, v₄, and v₅. All laser modes will generally emit optical power in both directions, and the ratio between output powers in the left and right directions will depend on the left and right end reflectivity of the laser cavity of a given mode. If desirable, the MW-DFB-FL can be made single polarization by using one of several known techniques. The fiber laser can be pumped by one or more pump sources, typically a semiconductor laser.

Although the FIGS. 1A and 1B shows a MW-FBG consisting of four subgratings, it is of course possible to fabricate MW-FBG and MW-DFB-FL with fewer as well as more subgratings. A MW-FBG and a MW-DFB-FL can be fabricated either by overlaying the subgratings one by one, or by fabricating a grating with an index profile equal to the sum of the individual subgratings.

In FIG. 2A the power distributions Pᵢ, i=2, . . . , 5, for incoming optical waves E(vᵢ) to an MW-FBG like the one shown in FIG. 1A is plotted. The frequency vᵢ of the wave is equal to one of the phase shift notch frequencies of the phase shifted MW-FBG. At each phase shift notch frequency, there will be a resonance around the phase shift of the corresponding subgrating. The power will fall off sharply in a close to exponential manner as a function of the product of distance from this phase shift and the subgrating strength. The modes of a MW-DFB-FL as shown in FIG. 1B, will have a similar modal spatial power distribution. FIG. 2A also shows a plot of an example of the spatial distribution of a measurand M along the fiber axis. The measurand can for instance be temperature, strain, static or acoustic pressure, force, or any other physical property that can perturb the effective refractive index, nₓ or n_{y}, periodicity Λ of the grating structure, or the birefringence B=nₙ−n_{y}of the fiber.

FIG. 2B-C schematically shows the effect of the perturbations caused by a varying measurand M as plotted in FIG. 2A on the different laser modes or phase shift notch frequencies of the structures shown in FIG. 1A or 1B. FIG. 2B shows the case of no external influence, i.e. M=0. FIG. 2C shows the effect of an external influence, i.e. M≠0. Because of the confinement of the power at the resonances, each laser mode or phase shift notch frequency depend mainly on the grating structure in near proximity to the corresponding subgrating phase shifts, and perturbations further away will have little effect. For pedagogic reasons, it has been assumed that the phase shift notch or laser frequency vᵢ and the position of the phase shifts zᵢ of each subgrating is ordered in the same way, but this is not necessary for the operation of the invention. Around z₂ and z₃ M is positive, resulting in a positive shift δv₂ and δv₃, respectively, of the corresponding resonance frequencies v₂ and v₃. Around z₄ and z₅, M is negative, resulting in a negative frequency shift δv₄ and δv₅ of the corresponding resonance frequencies v₄ and v₅, respectively. The sign of the ratio M/δvᵢ is here set arbitrarily and could be opposite for some measurands. Because of the perturbation, the beat frequency betweeen the resonance around phase shift i and phase shift j becomes:

ΔνᵢⱼΔνᵢⱼ⁰+δνⱼ−δνᵢ=νⱼ⁰−νᵢ⁰+δνⱼ−δνᵢi,j=2, . . . , 5 (2)

Here νᵢ⁰ is the resonance frequency of the phase shift i before the onset of the perturbation caused by M.

The ratio of change in birefringence to change in Bragg grating frequency depends on the type of measurand. Thus, it is, in some cases, possible to separate two measurands by simultaneously measuring the polarization splitting and frequency shift of the MW-FBG shown in FIG. 1A. Likewise, a dual measurand sensor can be made by measuring all frequencies or beat frequencies of a MW-DFB-FL as shown in FIG. 1B where all subgratings support lasing modes in both polarizations. Since this technique is known for conventional phase shifted gratings and DFB-FLs [6], it will not be described in any further detail here.

There are in principle an infinite number of ways of designing this invention, and in FIGS. 3-5 a few illustrating examples are given.

FIG. 3 illustrates a superposition of three uniform subgratings with equal coupling coefficients κ₁=κ₂=κ₃, all having a phase shift 9 of π in the middle. The subgratings, including their phase shifts 9, are spatially shifted from each other, leading to a grating structure similar to the ones shown in FIGS. 1A-1B. The subgratings are only partially overlapping, and the phase relation between the subgratings changes at each subgrating phase shift 9. This results in total coupling efficiency |κₜₒₜ| that varies significantly along the grating axis. |κₜₒₜ| is proportional to the required refractive index contrast.

In FIG. 4 another MW-FBG with three phase shifted subgratings is illustrated. The distance between the π phase shifts 9 of the different subgratings is the same as in FIG. 3, but each subgrating amplitude is varying along the fiber axis in such a way that the total required refractive index contrast is constant. At the same time, the reflectivity of each subcavity mirror was kept equal. This leads to a much shorter device length for a given grating reflectivity level than the one illustrated in FIG. 3, or for a given length a lower maximum index modulation. Furthermore, in order to increase the spatial resolution of the sensor, the resonant mode field distribution should be spatially separated as much as possible, and therefore the phase between the gratings are optimized in the region between the phase shifts.

The third example shown in FIG. 5 is also a structure consisting of three superimposed phase shifted Bragg gratings, with the same phase shift separation as in FIGS. 3-4. Here the subgratings are not overlapping between the phase shifts 9. Instead, the spatial resonance separation is enhanced by assigning each subgrating all available index contrast around its phase shift. The structure has similarity with the one shown in FIG. 4, in that the required refractive index contrast everywhere is the same, and in that the inter-grating phase is optimized at the edges of the grating.

FIG. 5 shows the calculated modal field distributions of a MW-DFB-FL of the design type illustrated in FIG. 6. The separation between each phase shift is 2.5 cm, the grating length is 12.3 cm, the maximum grating strength is |κₜₒₜ|=200 m⁻¹, and the difference in Bragg frequency between the different subgratings is Δν=10 GHz. These parameters are typical for a real grating. The power difference between the most powerful and next most powerful modes at the phase shifts are 20 dB at the center phase shift and 22 dB at the outer phase shifts. The spatial power distribution of the field at the different spectral phase shift notches with a passive grating will be similar.

Regardless of the principle chosen for the super-position of the subgratings, the fiber photosensitivity will be the limiting factor of the spatial resolution. With higher number of measurement points, the available photo-sensitivity has to be shared between more subgratings, leading to less confined resonance cavities and larger spatial overlap between the modes, and at some point the spatial resolution will not increase by increasing the number of gratings. For DFB-FL devices, each grating has to be strong enough to support a laser mode, which could limit the obtainable density of measurement points further. For passive, phase-shifted structures, weaker gratings means reduced resolution of the measurand.

For easy fabrication and interrogation of the invention, it is desirable to have the Bragg frequencies spaced as densely as possible. However, in order to avoid nonlinearities in the response, the stopbands and strongest sidebands of the different subgratings should not overlap. The smallest possible Bragg frequency separation between the subgratings is thus dependent on the coupling strength and linearity specifications.

In FIG. 7, the calculated transmission spectrum of the grating structure discussed in the previous paragraph without gain is plotted. Although there is some overlap between the sidebands, the three stopbands in the spectrum are clearly separated. The phase shift notch, which in the transmission spetrum in FIG. 7 appears as sharp peaks, are too narrow to be completely resolved by the simulations. In FIGS. 8A-B, 9A-B the effect of linear and quadratic chirp, respectively, in the structure is shown. In FIGS. 8A, 9A the detuning from the 10 GHz Bragg frequency spacing of the subgratings are plotted, whereas in FIGS. 8B, 9B the beat frequencies between the spatial middle mode and the left and right mode are plotted. In the linear chirp case, these two beat frequencies are equal to each other because of the symmetry of the device. The response is reasonably linear with a linear chirp ranging from −20 to 20 GHz/m and a quadratic chirp between −550 GHz/m² and 550 GHz/m². The range in the linear chirp case corresponds to a temperature gradient range of approximately ±17° C./m or strain gradient range of ±194 με/m. The range in the quadratic chirp case corresponds to a second order Taylor coefficient of approximately ±470° C./m² in temperature and ±5.3 mε/m² in strain.

FIG. 10 shows an embodiment of the invention where remote interrogation of a passive phase shifted MW-FBG sensor 1 with a tunable laser 16 is shown. The laser should scan over the phase shift notches of the MW-FBG 1 and either the reflected 17 or transmitted 18 light should be measured. By synchronizing the detector with the laser, the frequencies of the phase shift notches can be found. The tunable laser should have a narrow linewidth and in some cases it may be advantageous to monitor its output frequency to ensure accurate measurements, for example using a spectrometer. For higher resolution in time or measurand, it may in some applications be necessary to have several tunable lasers multiplexed at the source end of the system, with filters in the receiving end distributing the different frequencies to separate detectors.

FIG. 11 shows an embodiment of the invention where a typical interrogation setup of a MW-DFB-FL sensor is shown. From the pump source 19, which typically is a semiconductor laser, the pump light is guided through a wavelength division multiplexer (WDM) 20 and lead fiber 12 to the MW-DFB-FL 6. The laser light emitted from the pump side of the MW-DFB-FL 6 will be led back through the lead fiber 12 and to the signal arm of the WDM 20 for monitoring of the laser mode frequencies 22. To avoid back-reflection into the laser cavity an optical isolator 21 can be used. Alternatively, the MW-DFB-FL laser can be monitored from the right end of the MW-DFB-FL. Also when monitoring the various laser frequencies many techniques could be employed. Each laser frequency can be tracked independently by using an array of filters. Alternatively, beat frequencies between the modes can be measured with lower demands on filters but perhaps with increased requirements on fast electronics. For gradient sensors, the beat frequencies only are of interest, thus normally fast electronics. For other applications, the average state of the MW-DFB-FL sensor is of interest. In this case at least one of the MW-DFB-FL modal frequencies has to be determined.

FIGS. 12A and 12B show embodiments of the invention including serial and parallel multiplexing of the sensors. Such multiplexing will be useful for instance in distributed gradient measurements. In both fundamental ways of multiplexing, the gratings can be interrogated with the same optoelectronic units 23 and 24, i.e. the different MW-FBG 1 or MW-DFB-FL 6 sensors can share the same interrogating or pump sources, respectively, and receiving optoelectronics. In FIG. 12B, the light from the interrogating or pump sources is guided through a lead fiber to a coupler 25 or array of couplers that distribute the source light to the passive 1 or active 6 MW-FBG sensors. In the case where the sensor is interrogated at the output side, another coupler 25 is required to collect the signals from the various sensors in a common opto-electronic unit.

Other types of mulitplexing arrangement for example involving a combination of parallel and serial multiplexing are possible.

References:

[1] A. D. Kersey, M. A. Davis, H. J. Patrick, M. L. K. P. Koo, C. G. Askins, M. A. Putnam, and E. J. Friebele, “Fiber grating sources”, J. Lightwave Technol., vol. 15, no. 8, pp. 1442-1462, 1997.

[2] S. Huang, M. M. Ohn and R. M. Measures, “Phase-based Bragg intragrating distributed strain sensor”, Appl. Opt., vol. 35, pp 1135-1142, March 1996.

[3] J. Canning and M. G. Sceats, “π-phase-shifted periodic distributed structures in optical fibres by UV post-processing”, Electron. Lett., vol. 30, pp 1344-1345, August 1994

[4] J. T. Kringlebotn, J. Archambault, L. Reekie and D. N. Payne, “Er³⁺:Yb³⁺-codoped fiber distributed feedback laser”, Opt. Lett., vol. 19, pp 2101-2103, December 1994.

[5] J. T. Kringlebotn, “Optical fiber distributed feedback laser”, U.S. Pat. No. 5,844,927.

[6] E. Rønnekleiv, M. Ibsen, M. N. Zervas and R. I. Laming, “Characterization of fiber distributed-feedback lasers with an index-perturbation method”, Appl. Opt., vol. 38, pp 4558-4565, July 1999.

[7] M. Ibsen, K. M. Durkin, M. J. Cole and R. I. Laming, “Sinc-sampled fiber Bragg gratings for identical multiple wavelength operation”, IEEE Photon. Technol. Lett., vol. 10, pp 842-844. June 1998.

[8] M. Ibsen, E. Rønnekleiv, G. J. Cowle, M. N. Zervas and R. I. Laming, “Multiple wavelength all-fibre DFB lasers”, Electron. Lett., vol. 36, pp 143-144, January 2000

1. An optical device for distributed sensing of a measurand and/or changes thereof where the spectral transmission and reflection characteristics of the device depend upon the measurand comprising
a sensing section having at least one Bragg grating sensing structure in a waveguide,
said Bragg grating sensing structure comprising at least two superimposed or partly overlapping Bragg subgratings,
said Bragg grating sensing structure having at least two different Bragg wavelengths,
at least two of said Bragg subgratings comprise a phase-shift,
said Bragg subgratings having their phase shifts spatially separated from each other along the waveguide sensing section.

2. An optical device for distributed sensing of a measurand and/or changes thereof where the spectral emission characteristics of the device depend upon the measurand comprising
a sensing section having at least one Bragg grating sensing structure in a waveguide,
said sensing section is at least partly doped with rare earth ions and forming a laser medium,
said Bragg grating sensing structure comprising at least two superimposed or partly overlapping Bragg subgratings,
said Bragg grating sensing structure having at least two different Bragg wavelengths,
at least two of said Bragg subgratings comprise a phase-shift, said subgratings having their phase shifts spatially separated from each other along the sensing section.

3. The optical device according to claim 2, wherein the sensing section is spliced to conventional optical fibers at one or both ends.

4. The optical device of claim 1, wherein at least one of the Bragg subgratings has a varying strength or amplitude along the length of the grating.

5. The optical device of claim 1, wherein the relative phases between the subgratings are optimized such that for a given number of subgratings and subgrating strength the maximum total index modulation is minimized.

6. The optical device of claim 1, wherein the characteristics of the sensing section is sensitive to changes in an external parameter, the parameter selected from at least one member of the group consisting of strain, pressure and temperature.

7. The optical device of claim 1, wherein the characteristics of the sensing section is sensitive to changes in the temperature in the sensing section.

8. The optical device of claim 1, wherein the characteristics of the sensing section is sensitive to strain or stress in the sensing section.

9. The optical device of claim 1, wherein the waveguide is a polarization maintaining waveguide.

10. An optical distributed sensor for sensing an external physical parameter comprising
a tunable optical narrowband optical source for providing light to a first input port of an optical waveguide coupling section,
said coupling section having an output port coupled directly to or via a first waveguide lead section to one end of an optical waveguide sensing section,
detection means selected from at least one member of the group consisting of:
a first optical detection means coupled to the other end of the sensing section directly or via a second waveguide lead section for obtaining a measure of light transmitted through the sensing section, and
a second optical detection means coupled to a second input port of the said coupling section for obtaining a measure of light reflected by the sensing section,
wherein said sensing section comprises,
at least one Bragg grating sensing structure in a waveguide said Bragg grating sensing structure comprising at least two superimposed or partly overlapping Bragg subgratings,
said Bragg grating sensing structure having at least two different Bragg wavelengths,
at least two of said Bragg subgratings comprise a phase shift,
said Bragg subgratings having their phase shifts spatially separated from each other along the waveguide sensing section.

11. An optical distributed sensor for sensing an external physical parameter comprising:
an optical pump source for providing light to a first input port of a wavelength division coupler/multiplexer,
an output port of said coupler/multiplexer being connected directly to or via a waveguide lead section to an end of the optical waveguide sensing section,
optical detection means coupled to either one or both ends of the sensing section for monitoring light emitted in either one or both ends of the sensing section,
wherein said sensing section comprises at least one Bragg grating sensing structure in a waveguide at least partly doped with rare earth ions,
said Bragg grating sensing structure comprising at least two superimposed or partly overlapping Bragg subgratings,
said Bragg grating sensing structure having at least two different peak wavelengths,
at least two of said Bragg subgratings comprise a phase shift,
said Bragg subgratings having their phase shifts spatially separated from each other along the waveguide sensing sections, and
said structures are at least partly doped with rare earth ions.

12. The optical distributed sensor according to claim 10, wherein at least one of the subgratings has a varying strength or amplitude along the length of the grating.

13. The optical distributed sensor according to claim 10, wherein the tunable optical narrowband source comprises several tunable lasers and where the detection means comprises optical filters for separating light of different wavelengths from the lasers.

14. The optical distributed sensor according to claim 10, where the tunable source comprises means for monitoring the output wavelength of the tunable source.

15. The optical distributed sensor according to claim 10, wherein the detection means comprises means for measuring both frequency shift and polarization frequency splitting of phase shift notches of the Bragg grating structure.

16. The optical distributed sensor according to claim 10, comprising a multiple of Bragg grating structures coupled in a serial manner.

17. The optical distributed sensor according to claim 10, comprising a multiple of Bragg grating structures coupled in a parallel manner.

18. The optical distributed sensor according to claim 10, wherein the external physical parameter is selected from at least one member of the group consisting of:
temperature,
strain,
stress, and
pressure.

19. The optical device of claim 2, wherein at least one of the Bragg subgratings has a varying strength or amplitude along the length of the grating.

20. The optical device of claim 2, wherein the relative phases between the subgratings are optimized such that for a given number of subgratings and subgrating strength the maximum total index modulation is minimized.

21. The optical device of claim 2, wherein the characteristics of the sensing section is sensitive to changes in an external parameter, the parameter selected from at least one member of the group consisting of strain, pressure and temperature.

22. The optical device of claim 2, wherein the characteristics of the sensing section is sensitive to changes in the temperature in the sensing section.

23. The optical device of claim 2, wherein the characteristics of the sensing section is sensitive to strain or stress in the sensing section.

24. The optical device of claim 2, wherein the waveguide is a polarization maintaining waveguide, such as for example a birefringent optical fiber.

25. The optical distributed sensor of claim 11, wherein at least one of the subgratings has a varying strength or amplitude along the length of the grating.

26. The optical distributed sensor of claim 11, wherein the tunable source comprises means for monitoring the output wavelength of the tunable source.

27. The optical distributed sensor of claim 11, wherein the detection means comprises means for measuring both frequency shift and polarization frequency splitting of phase shift notches of the Bragg grating structure.

28. The optical distributed sensor of claim 11, comprising a multiple of Bragg grating structures coupled in a serial manner.

29. The optical distributed sensor of claim 11, comprising a multiple of Bragg grating structures coupled in a parallel manner.

30. The optical distributed sensor of claim 11, wherein the external physical parameter is selected from at least one member of the group consisting of:
temperature,
strain,
stress, and
pressure.
